(19) United States
(12) Patent Application Publication
(10) Pub. No.: US 2022/0051125 A1
(43) Pub. Date: Feb. 17, 2022

(54) INTELLIGENT CLUSTERING OF ACCOUNT COMMUNITIES FOR ACCOUNT FEATURE ADJUSTMENT

(71) Applicant: PAYPAL, INC., San Jose, CA (US)

(72) Inventors: Chun Kiat Ho, Singapore (SG); Jerry Tso, Singapore (SG); Junaid Zaheer Jaswal, Singapore (SG); Lin Song, Singapore (SG); Edwin Boaz Soenaryo, Singapore (SG); Shek Hei Wong, Singapore (SG); Harsha Singalreddy, Singapore (SG); Quan Jin Ferdinand Tang, Singapore (SG); Kai Xie, Singapore (SG)

(73) Assignee: PAYPAL, INC.

(21) Appl. No.: 16/990,823

(22) Filed: Aug. 11, 2020

(51) Int. Cl. G06N 20/00; G06Q 20/40; G06K 9/62

(52) U.S. Cl. CPC G06N 20/00; G06Q 20/405; G06Q 20/401; G06K 9/6256; G06K 9/6223; G06K 9/6215; G06K 9/6228

(57) ABSTRACT

There are provided systems and methods for intelligent clustering of account communities for account feature adjustment. A user may utilize an online account with the service provider to process transactions electronic. However, initially the account may be unverified or otherwise untrusted, and limits on electronic transaction processing may be imposed on the account. To provide intelligent feature adjustment, the service provider may utilize a machine learning technique to cluster verified accounts into communities based on their data representations. Thereafter, when a transaction by an unverified account violates a limit imposed on the unverified account, the service provider may process the unverified account using a machine learning model trained for account correlations to the community clusters in order to determine a corresponding community cluster of accounts and adjust a feature based on behaviors and traits of the verified accounts in the community cluster.

### TECHNICAL FIELD

The present application generally relates to intelligent clustering of accounts using machine learning, and more specifically to adjusting account features based on correlating accounts to account community clusters.

### BACKGROUND

Online transaction processors and other service providers may provide account services to different users, including consumers, merchants, and the like, to process transactions. Use of these services may require a user to generate and utilize an account with the service provider. The users may establish accounts by providing data, which initially may include a username, password, and other authentication information. However, the users may not initially provide sufficient data to verify the user's identity and/or otherwise become a trusted user of the online service provider. To address this problem, the service provider may impose limits on account usage when the account is not verified and/or while the certain user data or financial data is not provided to the service provider for account usage. As a result, a user may attempt to perform an online activity but may be barred from account usage prior to becoming verified and providing sufficient information.

### BRIEF DESCRIPTION OF THE DRAWINGS

FIG. 1 is a block diagram of a networked system suitable for implementing the processes described herein, according to an embodiment;

FIG. 2 is an exemplary system environment for training of community clusters of accounts and use of the community clusters to adjust account features of unverified accounts, according to an embodiment;

FIG. 3 is an exemplary diagram of account clusters used to correlate an unverified account to features of verified accounts in community clusters, according to an embodiment;

FIG. 4 is a flowchart of an exemplary process for intelligent clustering of account communities for account feature adjustment, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for intelligent clustering of account communities for account feature adjustment using machine learning techniques. Systems suitable for practicing methods of the present disclosure are also provided.

According to various embodiments, a user may establish an account with an online transaction processor or other service provider, where the account allows the user to utilize various services provided by the service provider, including transaction processing services for digital transactions. The account may be associated with a lifecycle, for example, based on establishing the account and entering information to maintain and verify the account. In this regard, when initially establishing the account, the account may not be verified prior to sufficient information being provided and stored with the account, such as an address, social security number (SSN), financial instrument, or the like. Moreover, when accounts are reactivated or used after a period of dormancy, the service provider may require verification data that the account has not been compromised or taken over. Thus, the service provider may impose limitations on the account to prevent fraud. However, users that are valid and merely have not performed sufficient verification steps may be barred from purchasing essential products or completing important transactions. Thus, the service provider may provide an intelligent clustering model generated using a machine learning technique that clusters communities of verified accounts based on account data. Using these clusters, the service provider may correlate one or more unverified accounts that is breaching an account limitation or other limit on transaction processing for the unverified account. The service provider may then utilize a trust rating and/or transaction processing habits and limits of the verified account community cluster corresponding to the unverified account to raise or adjust limitations imposed on the unverified account.

In various embodiments, to establish an account, a user may be required to provide information to a service provider. With regard to a service provider offering transaction processing services, one or more users may wish to engage in electronic transaction processing with one or more other entities, such as merchants or other users. Thus, the users of a transaction processor may correspond to both merchants and consumers. Various service providers may provide transaction processing services that may allow two or more entities (e.g., personal users, groups of users, merchants, etc.) to engage in electronic processing for a transaction. These service providers may further provide the aforementioned account services, which may be utilized through various services provided by the service provider. In order to establish the account, the user may be required to provide personal, business, or other identification information, such as a name, address, social security number, driver's license, and/or other information. The user may also be required to provide financial information, including payment cards (e.g., credit/debit cards), bank account information, gift cards, and/or benefits/incentives, which may be utilized to provide payments or otherwise engage in processing of another transaction. The user may select an account name and/or provide authentication credentials, such as a password, personal identification number (PIN), security questions, and/or other types of authentication information.

However, not all information may initially be proffered to establish the account and the account may be unverified or untrusted based on risk factors and fraud prevention. Moreover, accounts that are inactive for a period of time may include expired information, such as a payment card that has passed its expiration data, or personal information may be required to be updated, such as a new address of the corresponding user. The service provider may create or restore the account and may require the financial instruments of the user to allow the user to process transactions. In some embodiments, the service provider may provide a digital token, such as a data package, that represents a digital wallet for the account and may approve the digital wallet for processing of a transaction with the service provider to a device that receives the token. Thus, the token may include data identifying the digital wallet (e.g., a token), as well as authentication information including an identifier for the user of the digital wallet, which may be encrypted.

Once an account is created, the account may be accessed through a web browser from a website of the service provider and/or a dedicated application of the service provider, such as a mobile smart phone application. Thus, the user may directly access the account through an electronic communication channel, for example, through sending data to and receiving data from the service provider through a web browser/dedicated application over a network connection with the service provider. However, the service provider may utilize other communication mediums, including website banners, emails, text messaging, social networking feeds, etc. The user may engage in transaction processing through accessing their account and providing transaction information for the transaction. However, when an account is unverified or untrusted, the account may be limited. For example, the account may only process a transaction up to a limit (e.g., $500), which may be a maximum for a time period or in a single transaction. Other limits may also be imposed, such as a maximum balance, a withdrawal maximum, a limit on a number of transactions in a time period, a transfer limit, and the like.

In this regard, the service provider may implement an intelligent system including a machine learning clustering algorithm and engine that may be used to correlate unverified or untrusted accounts to community clusters of verified or trusted accounts. This may allow the service provider to adjust limits on electronic transaction processing, such as by increasing a limit if the community cluster correlated to the unverified account shows low risk or often processes a certain higher transaction amount. When clustering verified accounts, the service provider may first access account data for the verified accounts, which may include a transaction history of processed transactions account data to establish and/or verify the account (e.g., a name, location, address, financial instrument type, balance, etc.), and/or other available data associated with the account establishment and usage with the service provider. This may include personally identifiable information (PII) and/or know your customer (KYC) data, as well as other proprietary types of data for the service provider. Additionally, the service provider may determine additional information, such as device data for devices utilising the verified accounts, linked data for other accounts or services linked to the account, social networking data available for users of the accounts, or other data that may be accessible for the user and/or account. In some embodiments, product and merchant data for the transactions processed by the accounts may also be utilized.

Once the data is accessed, the data may be processed to extract features for training community clusters using a machine learning (ML) or other artificial intelligence (AI) clustering algorithm and technique. The feature extraction may correspond to determining a set of features that may be used as inputs when training and clustering accounts into communities. The training may be performed using an unsupervised ML operation based on the training data without annotations or classifications by a system administrator. However, in other embodiments, supervised training may also be utilized for training of the ML model and community cluster identifications. The ML clustering algorithm may include k-means clustering, a mean-shift clustering, a density-based clustering, or other intelligent clustering operations. Using the feature data, different community clusters of accounts may be determined by the ML clustering model, which may identify a group of accounts that are correlated or associated with each other, for example, based on a distance in vector space for a vector corresponding to each account. The ML model may determine the accounts in the vector space and utilize the clustering algorithm to generate the community clusters. Additionally, the types of accounts that are clustered may correspond to different types of users for the service provider, such as consumers and personal users that process transactions between other users and/or merchants, as well as merchant accounts and other entities. Furthermore, when clustering accounts, the account data used for feature extraction may be received over a time period and/or updated. For example, over an account lifecycle, additional account data may be received, data may be updated, and/or additional transactions may be processed. Thus, the ML model and corresponding account clusters may also be updated over time based on new data.

Thereafter, a request to process a transaction is received from an account that is unverified or has a risk or security concern that otherwise limits usage of the account. For example, the unverified account may have a limit on a maximum value for electronic transaction processing. The account may be limited by transaction amount, number of transactions, and/or parties to the transaction (e.g., cross-border transactions may be barred or limited to prevent fraud). The unverified account may be a newly established account that has not provided sufficient information or is in the process of having verification data processed and/or verified (e.g., verifying an address or SSN), or may correspond to a newly reactivated account that is required to provide some additional data to prevent fraud. When receiving the request to process the transaction, the service provider may determine that the transaction would cause some limit to be exceeded. For example, the service provider may determine that the transaction exceeds a $500 limit (e.g., is $510 or causes the transactions within a time period to be $510). In some embodiments, prior to performing a feature extraction on data and/or correlating the account to a community cluster, the service provider may also perform other checks on the data to determine whether an increased limit would benefit the unverified account and/or transaction when approving the transaction. For example, the service provider may determine whether an item or product in the transaction is essential (e.g., food, groceries, gas, or the like), or merely an entertainment item that may not be required. With essential items, increasing a limit and approving a transaction may have a higher rate of approval by the service provider, and thus may affect whether an account feature may be adjusted and/or the transaction is approved. The service provider may also determine whether the amount of the transaction exceeds the limit by such a high amount that increasing a limit is unlikely to cause transaction approval (e.g., if the transaction limit is $500 and the transaction is for $5,000). Other fraud checks and assessments may also be performed.

The service provider may then perform feature extraction of the unverified account's data and/or the transaction data for the transaction requested to be processed. This may include determining features that are the same or similar to those used to train the ML clustering model and generate the community clusters for the verified accounts of the service provider. The account data may also include other data for the unverified account and/or user associated with the unverified account, such as social networking information, contacts and/or communities, community friends and/or addresses, and other data that may be scraped or determined for online activities of the account and/or user. Thereafter, the ML model may be used to generate a representation of the unverified account in vector space, which may then be compared to the community clusters for verified accounts and users of the service provider. For example, the unverified account's representation may call into a clustered area within the vector space and/or may be within a certain distance of a community cluster center or other representation within the vector space. If the unverified account falls within a certain distance or area of more than one community cluster, such as where community clusters may overlap to a degree or the unverified account is within a distance that may cause correlation to two or more community clusters, the service provider may select a closest correlation (e.g., based on distance within vector space). In some embodiments, a similarity threshold (e.g., distance between representative vectors) may be required to be met or exceeded in order to perform a correlation between the unverified account and one or more community clusters. Thus, multiple community clusters may be correlated or removed from being correlated with the unverified account based on this similarity threshold. The service provider may also utilize traits for multiple community clusters when the unverified account is closest to multiple community clusters and/or may negate overlapping characteristics from different community clusters.

Thereafter, once the unverified account is correlated to one or more of the community clusters, the service provider may then utilize electronic transaction processing traits of the community cluster to determine whether to increase a limit set on electronic transaction processing for the unverified account. For example, the community cluster may have accounts that are used often to purchase essential products and items within the range of $500-$750 over a time period, or may generally have a monthly account statement balance or spending history over $500 (e.g., an average of $1,000 monthly expenditures). The community cluster may also have accounts that are used to perform cross-border transactions (e.g., commonly purchases from Europe), may process 10+ transactions in a month, or otherwise transaction in a greater amount than a limit imposed on the unverified account. In such embodiments, the service provider may determine that one or more limits imposed on the account may be increased based on accounts in the community cluster's behavior with less risk as the unverified account is behaving in the same or similar manner to the community.

For example, a comparison with verified accounts having similar transaction types may be used to determine whether to increase a limit and/or approve a transaction that exceeds a limit. In such embodiments, the transaction may be approved when the verified accounts in the community cluster process transaction in the same or similar manner, such as by purchasing the same or similar product. In some embodiments, a risk score may be determined based on the transaction type (e.g., for an essential item as determined by the service provider and/or the community cluster) and the community cluster's transaction behavior. For example, the community cluster's behavior may indicate that the verified accounts purchase items within a specific field, at a certain time, or for amount over a time period. The essential item may also be determined based on the transaction items for verified accounts in the community cluster, such as when the verified accounts purchase specific items. In such embodiments, the transaction may be compared and associated with other transactions by the verified accounts to determine whether to increase a limit on the unverified account and/or approve the transaction. However, in other embodiments, the community cluster may instead have accounts that are used to transact less than or at an even or similar level to the limit on the unverified account, which may indicate that the limit on the unverified account is appropriate and should not be increased due to potential risk of fraud. In such embodiments, no limit may be increased, and the transaction may be denied.

If the service provider determines that one or more limits on the unverified account for electronic transaction processing may be increased based on corresponding behavior and/or account usage by verified accounts in the corresponding community cluster, the service provider may increase the limit(s). This may be done permanently or temporarily and may enable allowance and processing of the single transaction and/or further transactions using the unverified account. For example, the service provider may temporarily increase the maximum transaction limit to allow a transaction for $510 exceeding a transaction amount limit of $500 to be processed. The service provider may temporarily increase just for the single transaction or may increase the limit for a time period and/or flat cap increase. In such embodiments, the transaction amount limit may be increased, for example to $750, if that is the average transaction expenditures in a time period for the community cluster, which may be renewed at further time periods or allowed only for the specific time period prior to the account becoming verified. Once the limit is increased, the service provider may determine whether the transaction now complies with the limits on electronic transaction processing for the account and may then process the transaction.

Additionally, the unverified account may receive updates to account data over time, which may change the unverified account into a verified account used as additional training data and/or change the unverified account's representation in vector space. Thus, the ML clustering model may be updated over time and/or the data for the unverified account may be reprocessed to determine if the account transitions to a new or different community cluster. In some embodiments, entry of account data for the unverified accounts may occur over time and/or over a lifecycle of the account when the user performs different verification steps, such as when a user enters a SSN, when the SSN is verified, and/or if the SSN is accepted or rejected (including number of times the SSN is rejected. Thus, analysis of one or more account verification steps may be performed to determine a lifecycle of the account and where the account's lifecycle is within a verification process. Using this data, the unverified account may also include additional behavior that may be used to correlate the unverified account to one or more community clusters. In some embodiments, when unverified accounts are processed by the ML clustering model (e.g., converted to a representation in vector space), those unverified accounts may also be used to train, retrain, and/or optimize the ML clustering model.

Additionally, while the community clustering operations may be applied to increasing account limits, in further embodiments, the ML clustering model may also be built to generate community clusters for other types of data and operations, which may also be used to associate accounts with community clusters and provide services. For example, a marketing or advertisement strategy may be determined for an account based on clustered communities. Risk avoidance and risk management may also be applied to accounts based on their corresponding community cluster(s) correlated to the account, which may also include determination of credit risk and extendable credit based on how risky an account may be from the corresponding community cluster. In some embodiments, sanction scans to disable accounts may also be used to fit accounts to community clusters of disabled or flagged accounts, which may allow for proactive disabling of accounts that may be risky or fraudulent based on the corresponding community clusters.

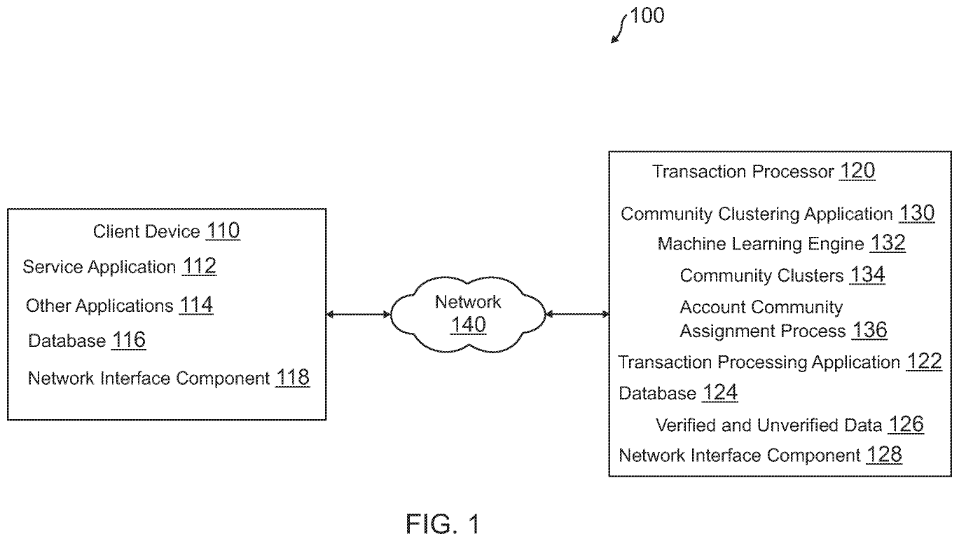

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a client device 110 and a transaction processor 120 in communication over a network 140. A user (not shown) may utilize client device 110 to utilize the various features available for client device 110, which may include processes and/or applications that may interact with services provided by transaction processor 120 to utilize an account with transaction processor 120. Transaction processor 120 may provide an intelligent AI process, such as an ML clustering engine having a trained ML model for account clustering, to assign the account for client device 110 to one or more community clusters of verified accounts. Based on the corresponding community clusters correlated to the account for client device 110, account features, such as electronic transaction processing limits, marketing strategies, risk assessments, and/or account sanctioning may be adjusted for the account for client device 110.

Client device 110 and transaction processor 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client device 110 may be implemented as a computing or communication device that may utilize appropriate hardware and software configured for wired and/or wireless communication with transaction processor 120, which may include personal and mobile computing devices of individual and/or groups of users of transaction processor 120, such as single users, merchants, and/or other entities. For example, in one embodiment, client device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. Although only one communication device is shown, a plurality of communication devices may function similarly.

Client device 110 of FIG. 1 contains a service application 112, other applications 114, a database 116, and a network interface component 118. Service application 112 and other applications 114 may correspond to executable processes, procedures, and/or applications with associated hardware. In other embodiments, client device 110 may include additional or different modules having specialized hardware and/or software as required.

Service application 112 may correspond to one or more processes to execute modules and associated components of client device 110 to interact with a service provider or other online entity that may provide account services to utilizes the resources and services of that service provider, such as transaction processor 120. In this regard, service application 112 may correspond to specialized hardware and/or software utilized by client device 110 to establish an account and utilize the account, which may include account usage prior to account and/or user verification based on limits that may be dynamically adjusted using community cluster correlations. Service application 112 may be used to register and access an account, such as by providing user personal and/or financial information, setting authentication information, queries, and challenges, and maintaining the account by providing other necessary information for account usage and/or verification. In this regard, with a transaction processor system, service application 112 may be used, during electronic transaction processing, to utilize user financial information, such as credit card data, bank account data, or other funding source data, as a payment instrument when providing payment information, including an account for electronic transaction processing of a transaction. For example, service application 112 may utilize a digital wallet associated with the account as the payment instrument, for example, through accessing a digital wallet or account of a user through entry of authentication credentials and/or by providing a data token that allows for processing using the account. Service application 112 may also be used to receive a receipt or other information based on transaction processing.

Service application 112 may correspond to a general browser application configured to retrieve, present, and communicate information over the Internet (e.g., utilize resources on the World Wide Web) or a private network. For example, service application 112 may provide a web browser, which may send and receive information over network 140, including retrieving website information, presenting the website information to the user, and/or communicating information to the website. However, in other embodiments, service application 112 may include a dedicated application of transaction processor 120 or other entity (e.g., payment provider, etc.), which may be configured to provide services through the application. Service application 112 may therefore be used to utilize account and service provider services provided by transaction processor 120. In this regard, while utilising an account, the account may be limited prior to account and/or user verification by transaction processor 120. Thus, transaction processor 120 may determine whether the account used by client device 110 is correlated to one or more community clusters intelligently determined based on an ML clustering model and verified account data. Transaction processor 120 may then provide one or more changes to the account to client device 110 while using the account, which may include limit increases and/or new processes, updates, account upgrades, and/or notifications that alerts the user of changes to account features. Thus, service application 112 may be used to receive services limit increases, advertisements, risk assessments and credit extensions, rewards, benefits, and/or notifications.

In various embodiments, client device 110 also includes other applications 114 as may be desired in particular embodiments to provide features to client device 110. For example, other applications 114 may include security applications for implementing client-side security features, programmatic client applications for interfacing with appropriate application programming interfaces (APIs) over network 140, or other types of applications. Other applications 114 may also include additional communication applications, such as email, texting, voice, social networking, and IM applications that allow a user to send and receive emails, calls, texts, and other notifications through network 140. Other applications 114 may be utilized with service application 112 to utilize an account, as well as provide device and/or user data to transaction processor 120. Other applications 114 may include device interfaces and other display modules that may receive input and/or output information. For example, other applications 114 may contain software programs, executable by a processor, including a graphical user interface (GUI) configured to provide an interface to the user.

Client device 110 may further include database 116 stored in a transitory and/or non-transitory memory of client device 110, which may store various applications and data and be utilized during execution of various modules of client device 110. Thus, database 116 may include, for example, identifiers (ID s) such as operating system registry entries, cookies associated with voice data application 120 and/or other applications 114, IDs associated with hardware of client device 110, or other appropriate IDs, such as IDs used for payment account/user/device authentication or identification. Database 116 may further include account information, as well as account usage limitations and notifications.

Client device 110 includes at least one network interface component 118 adapted to communicate with transaction processor 120. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Client device 110 may also communicate directly with nearby devices using short range communications, such as Bluetooth Low Energy, LTE Direct, Wi-Fi, radio frequency, infrared, Bluetooth, and near field communications.

Transaction processor 120 may be maintained, for example, by an online service provider, which may provide accounts and features to users through implemented services of transaction processor 120, including those account features associated with electronic transaction processing using an account In this regard, transaction processor 120 includes one or more processing applications which may be configured to interact with client device 110 and/or another device/server to facilitate application testing. In one example, transaction processor 120 may be provided by PayPal®, Inc. of San Jose, Calif., USA. However, in other embodiments, transaction processor 120 may be maintained by or include another type of service provider, which may provide the aforementioned services to a plurality of users.

Transaction processor 120 of FIG. 1 includes a community clustering application 130, a transaction processing application 122, a database 124, and a network interface component 128. Community clustering application 130 and transaction processing application 122 may correspond to executable processes, procedures, and/or applications with associated hardware. In other embodiments, transaction processor 120 may include additional or different modules having specialized hardware and/or software as required.

Community clustering application 130 may correspond to one or more processes to execute software modules and associated specialized hardware of transaction processor 120 to determine an ML model for clustering of digital accounts with transaction processor 120 into communities based on their corresponding account data, and further provide feature and service adjustments and updates based on those community clusters. In this regard, community clustering application 130 may correspond to specialized hardware and/or software to determine the ML clustering model for machine learning engine 132 and corresponding community clusters 134 using account data. Thus, community clustering application 130 may first access data used for feature extraction and training of the ML clustering model for machine learning engine 132, which may include at least verified account data for verified accounts (e.g., all or a portion of verified and unverified data 126 stored by database 124). The verified account information may correspond to verified accounts and/or users of transaction processor 120, which may include data for an account name, address, email, financial instruments, transaction history and other account activities, social networking data and connections, community connects and actions, and the like. Thereafter, a feature extraction process may determine feature data used to train the ML model of machine learning engine 132, for example, by training one or more nodes of the ML model for account clustering and classification.

For example, machine learning engine 132 may be generated based on training data from the features extracted from the verified account data and other data used for model training. When building machine learning engine 132, the training data may be used to generate one or more classifiers and provide outputs based on those classifications and the ML model. For example, machine learning engine 132 may include one or more layers, including an input layer, a hidden layer, and an output layer having one or more nodes, however, different layers may also be utilized. For example, as many hidden layers as necessary or appropriate may be utilized. Each node within a layer is connected to a node within an adjacent layer, where a set of input values may be used to generate one or more output values or classifications. Within the input layer, each node may correspond to a distinct attribute or input data type that is used to train machine learning engine 132.

Thereafter, the hidden layer may be trained with these attributes and corresponding weights using an ML algorithm, computation, and/or technique. For example, each of the nodes in the hidden layer generates a representation, which may include a mathematical AI computation (or algorithm) that produces a value based on the input values of the input nodes. The AI algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for machine learning engine 132. Thus, when machine learning engine 132 is used to perform a predictive analysis and classification of accounts, the input may provide a corresponding output that allows for accounts to be clustered.

Thus, machine learning engine 132 may be trained by using training data corresponding to the verified account data. By providing training data, the nodes in the hidden layer may be trained (adjusted) such that an optimal output (e.g., a classification) is produced in the output layer based on the training data. By continuously providing different sets of training data and penalizing machine learning engine 132 when the output of machine learning engine 132 are incorrect, machine learning engine 132 (and specifically, the representations of the nodes in the hidden layer) may be trained (adjusted) to improve its performance in data classification. Adjusting machine learning engine 132 may include adjusting the weights associated with each node in the hidden layer. Thereafter, machine learning engine 132 may be used to perform account classifications, such as by clustering accounts represented in vector space into community clusters 134. This may be done through k-means clustering, mean-shift clustering, density-based clustering, or another clustering algorithm for ML clustering models that cluster of accounts into particular clusters defined by community clusters 134.

Thereafter, community clustering application may utilize machine learning engine 132 with account community assignment process 136 to associate an unverified account used by client device 110 that is requesting processing of a transaction with one or more of community clusters 134. This may be done in response to transaction processing application 122 detecting that the transaction meets or exceeds a limit set on the unverified account for electronic transaction processing. In this regard, the unverified account may be associated with unverified account data, and the transaction may also include transaction data for items and participants in the transaction. Feature extraction may be used with the data for the unverified account and/or transaction to determine features used as input to machine learning engine 132. Thereafter, the unverified account may be represented in vector space that allows for association of the unverified account with one or more of community clusters 134 based on the distance from (a center, boundary, or other location) or representation within one or more of community clusters 134. Where multiple community clusters are correlated to the unverified account, a highest correlation may be used (e.g., shortest distance), account features and behaviors of multiple clusters may be used, or specific account behaviors may be negated when contradictory (e.g., when one account transaction behavior, such as spending amounts over a time period, is lower than a limit while another is higher than the limit).

Once account community assignment process 136 assigns the unverified account to one or more of community clusters 134, community clustering application 130 may determine if one or more limits on the unverified account may be increased, changed, or updated, as well as if the requested transaction may be processed or approved. The account limit may be increased permanently based on the corresponding community cluster's behavior, such as transaction processing history, expenditure amounts, transaction totals, transaction participants, and the like. In other embodiments, community clustering application 130 may instead temporarily increase the limit so that the transaction may be approved. Thereafter, community clustering application 130 may determine whether to process the transaction for the unverified account and may provide client device 110 with results and/or a transaction history based on processing the transaction. Community clustering application 130 may also determine whether to transmit a notification of the change to a transaction limit to the account, as well as other information about the community clustering operations (e.g., other available account limit increases, as well as verification steps). Moreover, community clustering application 130 may also use additional data and risk rules to determine whether to process the transaction, such as whether an item in the transaction is an essential item (e.g., groceries, gas, living expenses, etc.), whether the transaction would violate other risk rules for fraud protection, and/or other behavior of the unverified account that may indicate fraud.

Transaction processing application 122 may correspond to one or more processes to execute modules and associated specialized hardware of transaction processor 130 to provide account services to users, where the accounts may be used to process a transaction for a user or otherwise provide account services. In this regard, transaction processing application 122 may correspond to specialized hardware and/or software used by a user associated with client device 110 to establish an account with transaction processing application 122 by providing personal and/or financial information to transaction processor 130 and selecting authentication credentials. For example, in order to establish an account of to utilize services and interact with other entities, transaction processing application 122 may receive information requesting establishment of the account. The information may include user personal, business, and/or financial information. Additionally, the information may include a login, account name, password, PIN, or other account creation information. All of the data may not be initially received, and the account may be unverified prior to receipt of sufficient validation and verification data. The entity establishing the account may provide a name, address, social security number, or other personal or business information necessary to establish the account and/or effectuate payments through the account. Transaction processing application 122 may further use the account to provide services to users, for example through an account that may be established using transaction processor 120. The services may allow for a payment through a payment instrument. The account may be used to send and receive payments. The payment account may be accessed and/or used through a browser application and/or dedicated payment application executed by client device 110.

Additionally, transaction processor 120 includes database 124. As previously discussed, a user may establish one or more accounts and/or digital wallets with transaction processor 120. Account data in database 124 may include verified and unverified data 126 for accounts, which may correspond to user information, such as name, address, birth date, payment instruments/funding sources, additional user financial information, user preferences, and/or other desired user data. Users may link to their respective digital wallets and/or accounts through an account, user, and/or device identifier. Thus, when an identifier is transmitted to transaction processor 120, e.g., from client device 110, one or more digital wallets and/or payment accounts belonging to the users may be found. Database 124 may also store data processed by community clustering application 130, such as an ML clustering model trained using verified and unverified data 126, as well as community clusters 134 and/or account community assignment processes 136.

In various embodiments, transaction processor 120 includes at least one network interface component 128 adapted to communicate client device 110, and/or other devices/servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

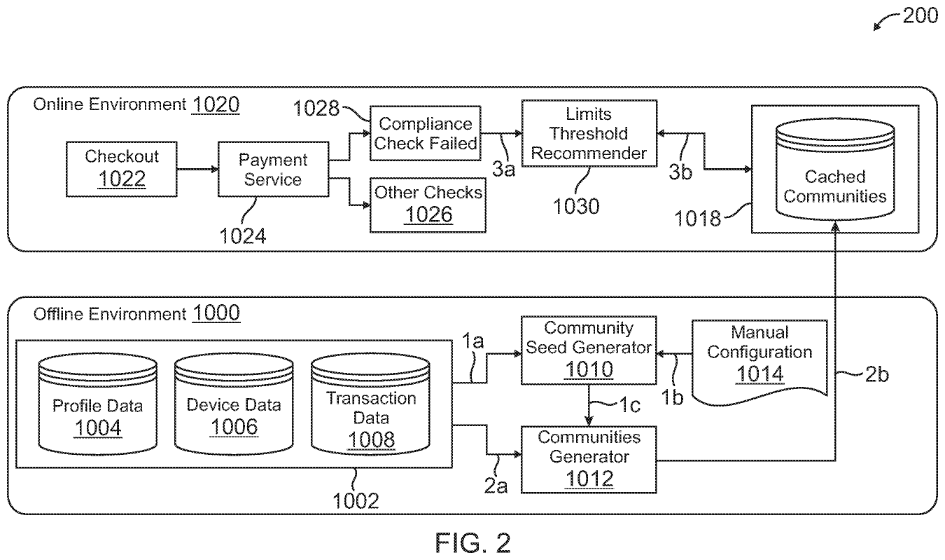

FIG. 2 is an exemplary system environment 200 for training of community clusters of accounts and use of the community clusters to adjust account features of unverified accounts, according to an embodiment. In system environment 200, users (e.g., consumers, merchants, or other entities) may be clustered depending on their corresponding accounts using an intelligent model trained for account classifications and clustering. Thus, system environment 200 includes interactions between a user's client device and a service provider, such as client device 110 and transaction processor 120, respectively, described in reference to system 100 of FIG. 1.

In system environment 200, initially an offline environment 1000 may perform operations to generate a set of community clusters of accounts, which may later be used in order to correlate unverified accounts during electronic transaction processing to a community cluster when a corresponding transaction meets or exceeds a limit on the unverified account. In this regard, in the offline environment, the online transaction processor or other service provider may first access training data 1002 corresponding to profile data 1004, device data 1006, and/or transaction data 1008 for verified accounts of the service provider that previously utilized the service provider's computing services and account features to process transactions electronically. At an operation 1a, training data may be provided to a community seed generator 1010, which may determine seed accounts used for clustering of accounts as represented within a vector space. When generating seeds for account clustering in vector space by community seed generator 1010, at operation 1b, manual configuration 1014 is used to provide a diverseness factor and/or bias that is utilized with a ML clustering algorithm and corresponding ML model for account clustering. However, in other embodiments, the configuration may also be automatic to define the diverseness of the account clusters (e.g., how large or small clusters may be by defining a maximum distance between accounts and/or a cluster center or seed used for account clustering). The seeds and corresponding communities may correspond to unverified accounts that have limitations. However, other types of community clusters may also be generated, such as those that correspond to marketing or advertisement strategies, risk and compliance, credit extensions, and/or account sanctioning and sanction scans.

Thereafter, using community seed generator 1010, the seeds used for account clustering are applied to communities generator 1012, at operation 1c. Thereafter, at operation 2a, communities generator 1012 utilizes a ML algorithm for account clustering with training data 1002 so that communities generator 1012 may generate one or more community clusters of verified accounts based on profile data 1004, device data 1006, and/or transaction data 1008. For example, a clustering algorithm, such as k-means clustering, mean-shift clustering, density-based clustering, or other ML clustering algorithm and technique based on representations of account data for the accounts. Thereafter, at operation 2b, the community clusters of accounts are then provided to and stored by cached communities 1018, which may be accessible in an online environment 1020. Further, cached communities 1018 may be updated over time based on changes to training data 1002 and/or additional account data added to training data 1002, including account data for unverified accounts in addition to verified accounts.

In order to then determine an update or change to a limitation on electronic transaction processing that is imposed on an account, in online environment 1020, a checkout 1022 is detected. Checkout 1022 may correspond to a request to process a transaction, such as a checkout operation on a website or through a mobile application. Checkout 1022 may be performed by an unverified account or other account that has a limitation imposed on the account for electronic transaction processing. In various embodiments, the limitation may be imposed on a consumer account, such as a maximum limitation on transaction approval or allowance (e.g., transaction amount, volume or number of transactions, etc.). However, in other embodiments, the limitations may be imposed on a merchant account, such as a withdrawal of funds from a merchant account. Thus, checkout 1022 may then proceed to a payment service 1024, which determines whether to process the transaction. Payment service 1024 may interact with account limitation compliance checks, which may determine whether the transaction may proceed based on limitations set for the account.

In online environment 1020 payment service 1024 determines that checkout 1022 has a compliance check failure 1028 when performing the compliance checks. There may also be other checks 1026 on checkout 1022 by payment service 1024, such as those associated with whether the transaction includes essential items, a financial instrument is valid for payment processing, whether authentication has been passed, if an account takeover is detected, and the like. In response to compliance check failure 1028, at step 3a, a limits threshold recommender 1030 is called, which may correspond to the ML clustering model and engine that allows for correlating an account performing checkout 1022 to one or more of cached communities 1018. Thereafter, limits threshold recommender 1030 then interacts with cached communities 1018, such as by performing an API call to request or retrieve data from a cache or database, in order to determine the community clusters for cached communities 1018. Limits threshold recommender 1030 then utilizes features from the account's data that is requesting checkout 1022, which may be provided to a ML engine for correlating the account to one or more community clusters from cached communities 1018. Thereafter, based on the behavior of the accounts in the correlated community cluster(s), the limit of the account may be increased or otherwise adjusted. The behavior may correspond to electronic transaction processing behaviors, trends, or traits that indicate whether a limit may be increased (e.g., based on the accounts within the cluster processing more, less, or different transaction data and amounts).

Moreover, other types of services and features may also be updated or adjusted based on the community cluster corresponding to the processed account. For example, if the account corresponds to a community cluster of accounts for a particular successful or selected marketing strategy, the marketing strategy may be applied to the account. Similarly, risk and fraud rules or assessment, such as those associated with extending credit to a user, may be correlated to the account based on the corresponding community cluster. A sanction scan and sanctioning of a fraudulent or abusive account may also be performed if the account is correlated to other communities of clustered accounts that were fraudulent or malicious.

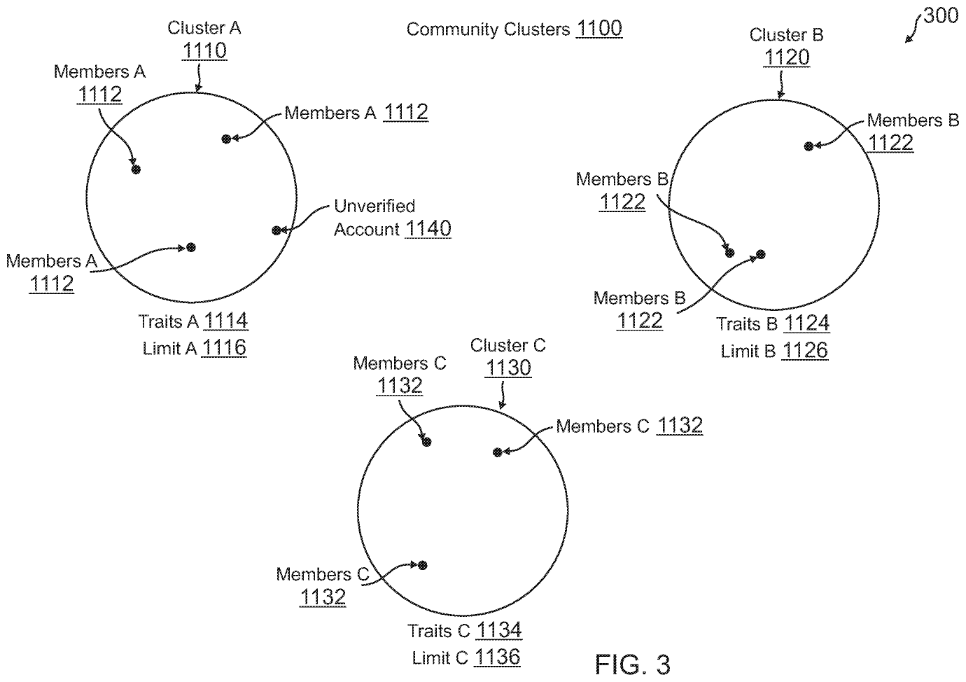

FIG. 3 is an exemplary diagram 300 of account clusters used to correlate an unverified account to features of verified accounts in community clusters, according to an embodiment. Diagram 300 is a representation of three different account clusters in a vector space, where representing another account in that vector space may be used to correlate that account to a specific community cluster of accounts. Correlating the account to a community cluster may be used to predict behavior of the account and adjust account limits, either by increasing or decreasing a limitation, or otherwise altering, based on common behavior and trends from the community cluster. However, other representations of account clusters may also be utilized based on the corresponding clustering technique and ML model for account clustering.

In diagram 300, community clusters 1100 include three community clusters, a cluster A 1110, a cluster B 1120, and a cluster C 1130. In cluster A 1110, members A 1112 show three members within an area defined by cluster A 1110, in cluster B 1120, members B 1122 show three members within an area defined by cluster B 1120, and in cluster C 1130, members C 1132 show three members within an area defined by cluster C 1130. However, in other embodiments, more or less accounts may be used to define cluster A 1110, cluster B 1120, and cluster C 1130. Community clusters 1100 may be generated as described in FIG. 2, for example, based on a ML clustering algorithm used to train a ML model and generate community clusters 1100.

Each of cluster A 1110, cluster B 1120, and cluster C 1130 are further associated with traits or behaviors for the accounts within the corresponding community cluster, as well as limits on transaction processing or other account usage. For example, with cluster A 1110, traits A 1114 may correspond to common traits shared between the accounts in members A 1112 based on their behaviors and usages. Similarly, cluster B 1120 includes corresponding traits B 1124 and cluster C 1130 includes corresponding traits C 1134. Traits A 1114, traits B 1124, and traits C 1134 may correspond to different traits shared by the members of the community clusters, such as the verified accounts, which may include location, transaction processing behaviors, lifecycle information, and the like.

Using traits A 1114, traits B 1124, and traits C 1134, as well as other behavioral information and/or account limits for members A 1112, members B 1122, and members C 1132, respectively, limits for members within the community and/or for unverified accounts that are correlated to the community, may be determined. For example, limits A 1116, limits B 1126, and limits C 1136 may be determined for cluster A 1110, cluster B 1120, and cluster C 1130, respectively. Limits A 1116, limits B 1126, and limits C 1136 may define increases or decreases to account features and services, such as by increasing a transaction limit allowable for an unverified account that becomes correlated to the corresponding community cluster. For example, an unverified account 1140 is shown within a cluster distance or designation for cluster A 1110. Unverified account 1140 may include one or more account limitations that may prevent electronic transaction processing for a specific transaction. However, based on traits A 1114, the limitations on unverified account 1140 may be increased, lifted, or otherwise changed to allow for processing the transaction. Further, although limits A 1116, limits B 1126, and limits C 1136 are associated with cluster A 1110, cluster B 1120, and cluster C 1130, in other embodiments, other data may be associated with each cluster. For example, a marketing or advertisement strategy, risk assessment and credit extension, and/or sanction scan may be associated with community clusters when generated by a ML model.

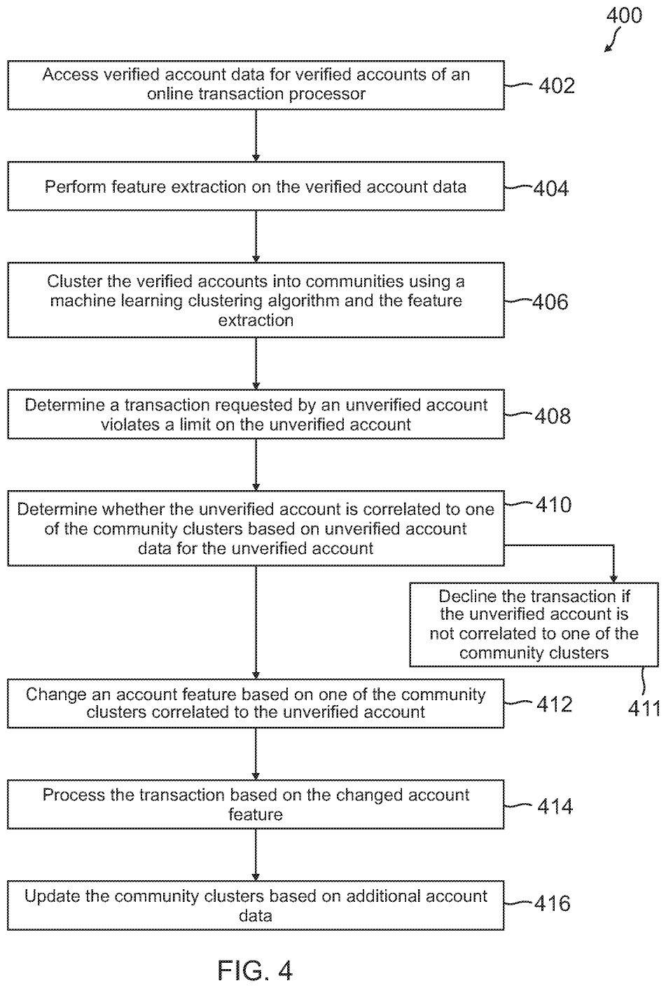

FIG. 4 is a flowchart 400 of an exemplary process for intelligent clustering of account communities for account feature adjustment, according to an embodiment. Note that one or more steps, processes, and methods described herein of flowchart 400 may be omitted, performed in a different sequence, or combined as desired or appropriate.

At step 402 of flowchart 400, verified account data for verified accounts of an online transaction processor is accessed, such as those accounts that have completed a verification process to provide sufficient personal, business, or financial information to become trusted and receive access to transaction processing services. The data may be accessed in order to provide community clustering for verified accounts in order to correlate unverified accounts to the verified accounts and adjust account features and services. However, in other embodiments where different community clustering operations may be used (e.g., marketing, risk, sanctioning), different account data and/or clustering may be performed, for example, to identify different groupings of accounts. Once the verified account data is accessed, at step 404, feature extraction is performed on the verified account data in order to determine features used as input and/or training data for clustering the verified accounts into communities.

The verified accounts are clustered into communities using a machine learning clustering algorithm and feature extraction, at step 406. The ML clustering algorithm may cluster using of a k-means clustering, a mean-shift clustering, a density-based clustering operation, or one or more other ML clustering algorithms based on representations of the accounts in vector space or otherwise correlating the accounts based on their corresponding account data. Thus, different ML clustering algorithms may be selected for use based on a data set and/or accuracy of the ML clustering algorithm. The ML clustering algorithm may also determine the communities having clustered accounts based on training data for the verified accounts, which may correspond to training features extracted from the verified account data from step 404. Thus, a ML model may be trained using the training data in order to correlate accounts, which may use unsupervised learning. However, supervised learning may also be used in some embodiments where annotations may assist in performing outputs, classifications, and values.

Once the communities are generated, the communities may be applied to unverified accounts or other accounts in order to associate those accounts with a particular community and provide a feature update, change, increase, or service based on the traits and behaviors of the corresponding community. Thus, at step 408, a transaction requested by an unverified account is determined to violate a limit on the unverified account. The transaction may correspond to a purchase by a consumer, or may correspond to merchant transactions, such as withdrawals, incoming payments, and the like. Thus, the unverified account may be processed using the communities to determine whether an account feature may be adjusted to allow for processing of the transaction, such as temporarily or permanently increasing a limit on electronic transaction processing. However, if the transaction does not meet other rules checks (e.g., is too far over a limit, is otherwise suspicious or risky, does not include an essential item, etc.), the transaction and unverified account may not be processed or is denied using the communities to check for a feature limit increase, such as a maximum transaction value increase.

At step 410, the service provider determines whether the unverified account is correlated to one of the community clusters based on unverified account data for the unverified account. The unverified account may be processed using features for the unverified account data, the ML clustering model trained using the verified account data, and the community clusters generated for the verified accounts. This may include transforming the unverified account data into a representation, such as a vector or other representation in vector space and comparing that vector distance to one or more community clusters. Thereafter, the unverified account may be correlated to a community that include verified accounts having the same or similar behaviors and traits, which may indicate a trust level and potential behavior of the unverified account. Additionally, rules may also be utilized for community selection when overlapping communities may exist or the unverified account may be weakly or strongly correlated to multiple communities. If the unverified account is not correlated to one of the community clusters, at step 411, the transaction is declined. For example, the unverified account may not be within an area designated for a community cluster based on the intelligent clustering, such as within an area defined for a cluster of verified accounts using k-means clustering. In other embodiments, the representation or vector may not be within a maximum threshold distance from a representation of a community cluster and/or verified accounts within the community cluster. Thus, the unverified account may not be correlated to a community cluster if the ML clustering model cannot satisfy a condition required for correlating the unverified account to one of the community clusters. Further, when declining the transaction, the feature of the unverified account may not be changed, such as by declining to increase the limit on electronic transaction processing for the unverified account.

However, if the unverified account is correlated to one of the community clusters, at step 412, an account feature is changed based on the one of the community clusters that is correlated to the unverified account. For example, the online transaction processor may determine traits and behaviors for accounts in the community cluster, such as an average spending amount for the community cluster (which may be over a time period), a number of transactions over a time period, transaction behaviors and participants (e.g., cross-border, user-to-user, merchant purchases, etc.), and the like. Based on this behavior, a risk analysis may be made of whether the unverified account is behaving similar to the community cluster based on the correlation to the community cluster. If the community clusters traits and behaviors indicate it is not risky to increase a limit or otherwise adjust a feature or service of the account, the service provider may perform the feature adjustment and change the account feature, such as a limit increase, for the unverified account.

The transaction is then processed at step 414 based on the changed account feature. For example, the account feature may indicate that an increased transaction processing limit, amount, or level can be made available to the unverified account. The service provider may determine whether this increased limit allows for transaction processing. If the increased limit allows the transaction to be approved, the online transaction processor may process and approve the transaction, otherwise, the transaction may be declined for exceeding the new increased limit. At step 416, the community clusters are then updated based on additional account data. For example, after a time period, the ML clustering model and community clusters may be retrained and rebuilt due to changes to the verified accounts and additional accounts that become verified. Further, unverified account data may also be added to the training, including increased limits and unverified account assignments. This may occur where the unverified accounts benefited from an increased limit and did not cause additional fraud.

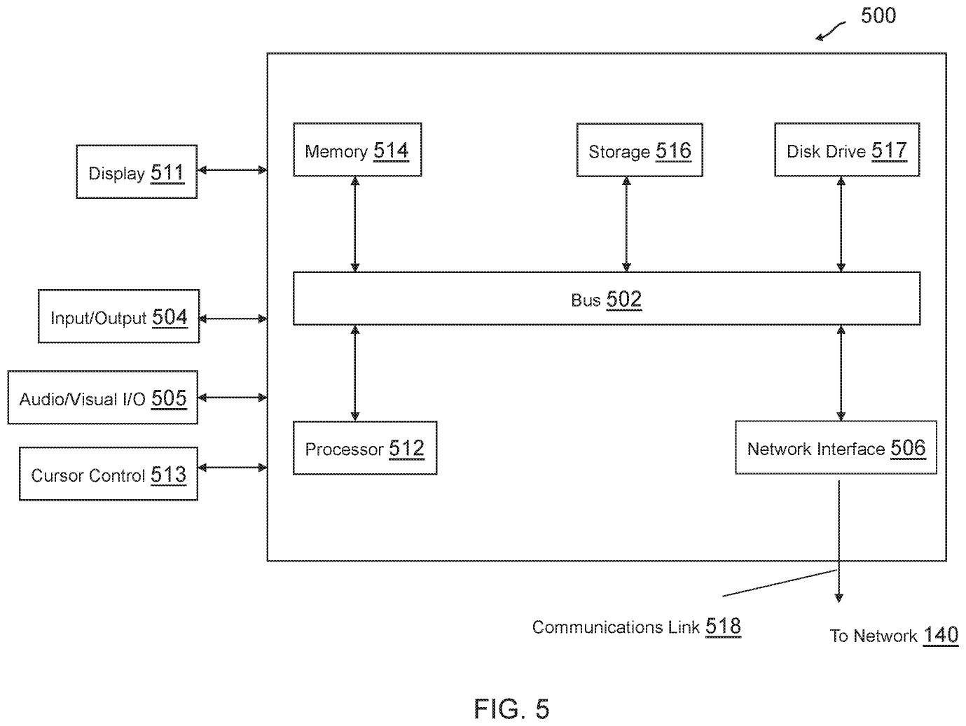

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
receiving a request for a transaction associated with an account for an online transaction processor associated with the system, wherein the request comprises transaction data for the transaction;
determining that the transaction would cause a transaction limit associated with the account to be exceeded;
identifying feature data for the transaction based on at least one of the transaction data or account data for the account;
determining, using the identified feature data and a machine learning clustering technique, a first community cluster of a plurality of community clusters that corresponds to the identifier feature data, wherein the plurality of community clusters correspond to a plurality of verified accounts of the online transaction processor;
determining an increased limit for the transaction limit of the account based on the first community cluster; and
processing the transaction based on the transaction data and the increased limit.

2. The system of claim 1, wherein the processing the transaction comprises determining that the transaction complies with the increased limit, and wherein the operations further comprise:
updating the account with the increased limit; and
processing the transaction based on the transaction data and the increased limit.

3. The system of claim 1, wherein the processing the transaction comprises determining that the transaction meets or exceeds the increased limit, and wherein the operations further comprise:
declining the transaction based on the transaction data and the increased limit; and
transmitting a notification to the account that comprises verification operations for at least one of verifying the account or approving the transaction.

4. The system of claim 1, wherein the increased limit increases at least one of a maximum transaction amount, a maximum number of transaction within a time period, or a maximum account balance.

5. The system of claim 1, wherein prior to the receiving the request, the operations further comprise:
accessing verified account data for the plurality of verified accounts;
performing a feature extraction on the verified account data; and
determining the plurality of community clusters using the machine learning clustering technique and the performing the feature extraction.

6. The system of claim 5, wherein the determining the plurality of community clusters uses an unsupervised training operation with the verified account data.

7. The system of claim 6, wherein the operations further comprise:
retraining the plurality of community clusters using unverified account data for a plurality of unverified accounts of the online transaction processor.

8. The system of claim 5, wherein the operations further comprise:
receiving updated verified account data for the plurality of verified accounts after a period of time;
processing the updated verified account data using the machine learning clustering technique;
detecting a community shift by at least one of the plurality of community clusters from the processing the updated verified account data; and
retraining at least the one of the plurality of community clusters based on the community shift.

9. The system of claim 5, wherein the plurality of verified accounts correspond to at least one of profile data for the plurality of verified accounts, device data for devices associated with the plurality of verified accounts, or past transaction data for past transactions processed by the plurality of verified accounts.

10. The system of claim 1, wherein the machine learning clustering technique comprises one of a k-means clustering, a mean-shift clustering, a density-based clustering, or another machine learning clustering operation.

11. The system of claim 1, wherein the determining the first community cluster comprises:
determining, for the account using the machine learning clustering technique, a subset of the plurality of community clusters associated with the account based on the plurality of community clusters and the feature data; and
determining the first community cluster based on one of a shortest vector distance or a rule for community cluster assignment for the plurality of community clusters.

12. The system of claim 1, wherein the account comprises an unverified account and the account data comprises at least one of social network data, one or more past transactions by the unverified account, one or more geo-locations associated with the unverified account, or device data for one or more devices used by the unverified account, and wherein the transaction comprises one of a user purchase transaction or a merchant withdrawal transaction.

13. A method comprising:
obtaining account data for a plurality of accounts of an online transaction processor;
determining feature data from the account data using a feature extraction operation with the account data, wherein the feature extraction operation is associated with a machine learning operation that clusters a plurality of account communities;
clustering the plurality of accounts in a vector space using the feature data and the machine learning operation; and
generating the plurality of account communities for the plurality of accounts based on the clustering.

14. The method of claim 13, wherein the plurality of accounts comprise at least one of verified accounts of the online transaction processor or unverified accounts of the online transaction processor.

15. The method of claim 13, further comprising:
determining an unverified account of the online transaction processor, wherein the unverified account is associated with unverified account data;
associating the unverified account with one of the plurality of account communities based on the unverified account data and the machine learning operation; and
determining a change to an account feature for the unverified account based on the one of the plurality of account communities associated with the unverified account.

16. The method of claim 15, further comprising:
determining an update to the unverified account data at a lifecycle stage of the unverified account;
determining whether the one of the plurality of account communities associated with the unverified account is changed based on the update; and
determining whether the change to the account feature is updated based on the determining whether the one of the plurality of account communities is changed.

17. The method of claim 15, wherein the account feature is associated with one of an increased transaction amount, an increased withdrawal limit, a marketing program, a risk compliance standard, a credit limit, or an account sanction.

18. The method of claim 15, wherein the unverified account data further comprises a number of account verification attempts for an account verification process.

19. The method of claim 13, wherein the account data comprises one of a user name, an account address, a payment card registration, an email address, an IP address, a network provider, an operating system, a device location, a device type, a sender account number and/or name, a recipient account number and/or name, a transaction amount, a product description, a transaction type, or a funding source.

20. A non-transitory machine-readable medium having stored thereon machine-readable instructions executable to cause a machine to perform operations comprising:
establishing a plurality of user communities for verified users of an online transaction processor using past transaction data for past transactions processed by the verified users and a machine learning operation for clustering the verified user based on the transaction data;
receiving transaction data for a transaction that an unverified user requests to be processed by the online transaction processor, wherein the unverified user is associated with unverified user data with the online transaction processor;
determining that the transaction exceeds a transaction limit set for the unverified user;
correlating the unverified user with one of the plurality of user communities based on at least one of the transaction data or the unverified user data;
determining an increase to the transaction limit for the unverified user based on the one of the plurality of user communities; and
processing the transaction based on the increase.
